(19) United States
(12) Patent Application Publication
(10) Pub. No.: US 2018/0018737 A1
(43) Pub. Date: Jan. 18, 2018

(54) SYSTEM AND METHOD FOR APPLYING PREDICTIVE SOCIAL SCORING TO PERFORM FOCUSED RISK ASSESSMENT

(71) Applicants: Max Drucker, Santa Barbara, CA (US); Geoffrey R. Andrews, Goleta, CA (US)

(72) Inventors: Max Drucker, Santa Barbara, CA (US); Geoffrey R. Andrews, Goleta, CA (US)

(21) Appl. No.: 15/546,590

(22) PCT Filed: Jan. 26, 2016
(86) PCT No.: PCT/US16/14949

§ 371 Date: Jul. 26, 2017

Related U.S. Application Data
(60) Provisional application No. 62/111,996, filed on Feb. 4, 2015.

(51) Int. Cl. G06Q 40/08; G06Q 10/10; G06Q 40/02; G06Q 50/00

(52) U.S. Cl. CPC G06Q 40/08; G06Q 50/01; G06Q 10/1053; G06Q 40/025

(57) ABSTRACT

A system and method for determining a risk score for a target subject using social media is provided. A potential subject is identified and publicly available online content relating to the subject, such as information from social networking websites, blogs, and other social media, is collected and verified. Using a predictive scoring process, the verified information is compared to an existing data set of known outcomes, and a final determination of risk for the target subject is provided. The process may be tailored to a specific use case, such as applications for insurance, employment, or a loan. The final determination of risk may be expressed as a recommended action, such as a green light recommending approval of the application, or a red light recommending denial of the application. Alternatively, a red light application may be approved at an increased price or rate.

### CLAIM OF PRIORITY AND CROSS-REFERENCE TO RELATED APPLICATION

This application claims the benefit of and priority to U.S. Provisional Patent Application No. 62/111,996, which was filed on Feb. 4, 2015, and is incorporated herein by reference in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### TECHNICAL FIELD

The present disclosure relates to risk analysis, and, more particularly, to a system and method for applying predictive social scoring to perform focused risk assessment.

### BACKGROUND

There is a voluminous amount of data publicly available online, with individuals contributing additional data each second. For example, users may provide information via social networking websites, online commerce websites, media sharing websites, news websites, and many other types of mechanisms. However, given the volume of information, the ease of creating “new” web identities, the relative anonymity or lack of verification of data, and other similar reasons, it can be challenging to determine what data may be accurately attributed to a particular individual.

When attempting to evaluate risk associated with an individual, the voluminous information available online, if analyzed properly, could provide valuable insights. Furthermore, these insights may not be available via other means. For these reasons and others, it is desirable to develop a system and method to apply predictive social scoring to perform focused risk assessment. Aspects of the present disclosure fulfill these and other desires.

### SUMMARY

According to aspects of the present invention, a method for providing a risk assessment recommendation based at least in part on publicly available online information is presented. The method comprises identifying a target subject to be evaluated, searching for and collecting available online information for content about the target subject, validating the collected information, selecting specific features associated with the information, receiving at least one known outcome from a database for at least one specific feature, evaluating the subject data in comparison with the known outcome(s), and providing a risk score for the target subject.

According to further aspects of the present invention, a system for providing a recommended action for a target subject and specific use case is disclosed. The system comprises one or more processors communicating with an online network, a database in communication with the processor(s), and one or more memory devices storing instructions that, when executed by the processor, cause the system to receive a request pertaining to a target subject and specific use case, search the online computer network for information about the subject, store the information as profile data for the subject, select a plurality of features according to the specific use case, evaluate the profile data in comparison with known outcome information from the database, and determine a recommended action for the target subject and specific use case per the evaluation.

According to further aspects of the present invention, a method for determining an insurance quote for a target subject is disclosed. The method includes receiving a request for an insurance quote for a subject, obtaining publicly available data for the subject, verifying the obtained data and strong it as profile data, evaluating the profile data according to a plurality of known outcomes to determine a numerical predictive risk score for the subject, and providing a rate quote for the subject based on the numerical risk score, where a lower risk score is associated with a lower rate quote.

These and other capabilities of the invention, along with the invention itself, will be more fully understood after a review of the following figures, detailed description, and claims.

### BRIEF DESCRIPTION OF THE DRAWINGS

FIG. 1 illustrates exemplary network data sources for the social scoring process, according to an embodiment of the present disclosure.

FIG. 2 illustrates potential factors considered as part of the social score, according to an embodiment of the present disclosure.

FIG. 3 is a flowchart of the scoring process, according to an embodiment of the present disclosure.

FIG. 4 is a flowchart of an insurance quote process using the Social Intelligence® social scoring process, according to an embodiment of the present disclosure.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.” Additionally, the singular terms “a,” “an,” and “the” include plural referents unless context clearly indicates otherwise.

The disclosure herein provides capabilities to collect, analyze, and apply electronic information that is publicly available online. Using these capabilities, the system and method disclosed herein can be applied to a risk management decision process, such as insurance quotations and/or underwriting, and provide a recommended action. As detailed further below, the process includes identifying a potential subject and collecting online content potentially relating to that subject. Next, a verification mechanism, such as the Social Intelligence® Identity Resolution Engine, is used to validate data potentially relating to the subject. Then, the validated data is analyzed using a predictive scoring process, leading to a final determination of risk for the potential subject. In some embodiments, the final determination is expressed as a “green light” report, where a green light indicates a good risk that does not require further investigation, and a red light indicates an undesirable risk that, at a minimum, requires further investigation.

In some embodiments, the disclosure herein may be applied to the insurance application process. For example, a subject applying for insurance, such as car insurance, can be analyzed using the system and methods herein, which will identify the subject as either a good risk that can be quickly processed, or an unknown risk that requires further investigation, such as a credit check, motor vehicle report, claim history, and/or other types of additional data before accepting the application. In other embodiments, the disclosure may be applied to other types of insurance, such as home insurance, life insurance, umbrella policies, and other types of insurance policies.

In still other embodiments, the disclosure may be applied to many other situations where the risk or credibility of a subject requires evaluation. For example, the disclosure may assist with employment background checks, litigation support, corporate investigations, vendor screening, and many other applications where it is desirable to identify and/or avoid high-risk subjects. According to some embodiments, the predictive scoring capabilities may be applied to loan applications or other lending analysis.

According to embodiments where the risk analysis is related to a financial instrument, such as an insurance policy or a loan, the payment required by the applicant can be varied according to the predictive score for the applicant. In some embodiments, the predictive scoring determination is expressed according to a numeric range or other scale of relative risk scores. For example, according to some embodiments, a low risk applicant may be identified as an “A” and a higher risk applicant may be identified as a “C”, with an extremely high risk applicant identified as an “F”. Furthermore, the applicable payment terms, for example, an insurance premium or interest rate, can be adjusted such that an applicant rated “A” pays a slightly lower amount than an applicant rated “B”.

The voluminous amount of publicly available online information may provide data relating to a subject's financial status, arrest record, drug use, driving history, purchasing behavior, consumer sentiment, social connections, life events, and many other areas. A “traditional” analysis, such as analyzing a subject's credit history and motor vehicle records in order to evaluate insurance risk, provides a limited picture of a subject's risk profile. The expanded analysis disclosed herein, using social media and other online information to evaluate risk, provides access to data not previously available and potentially presents a better picture of a subject's potential risk.

The system and method for predictive social scoring disclosed herein can be performed using one or more processors directly or indirectly connected to an online network, such as the Internet. The one or more processors are configured to communicate with a tangible machine-readable storage media including instructions for performing the operations described herein. Machine-readable storage media includes any mechanism that stores information and provides the information in a form readable by a processor. For example, machine-readable storage media includes read only memory (ROM), random access memory (RAM), magnetic-disk storage media, optical storage media, flash memory, etc. The one or more processors are configured to accept input from an input device, such as a keyboard, mouse, touchscreen, or other input mechanism, and provide output via an output device such as a display, printer, speaker, or other output mechanism. The one or more processors may be part of a desktop computer, laptop, server, mobile phone, tablet, or other device with sufficient processing power, input/output capabilities, and connectivity to perform the operations described herein. In some embodiments, the one or more processors may be distributed across multiple devices to improve processing speed and/or accessibility.

According to some embodiments, the one or more processors communicatively coupled to a local database with data detailing known outcomes, based on actual risk data from validated subject content. In other embodiments, the database is a remote or network database available over an online network, such as an intranet or the Internet. Additionally, the database may be updated based on additional information from actual use cases. For example, in the automotive insurance context, an actual loss claim (for example, a car accident) for an existing subject may be used to further refine the social scoring process, as discussed further below.

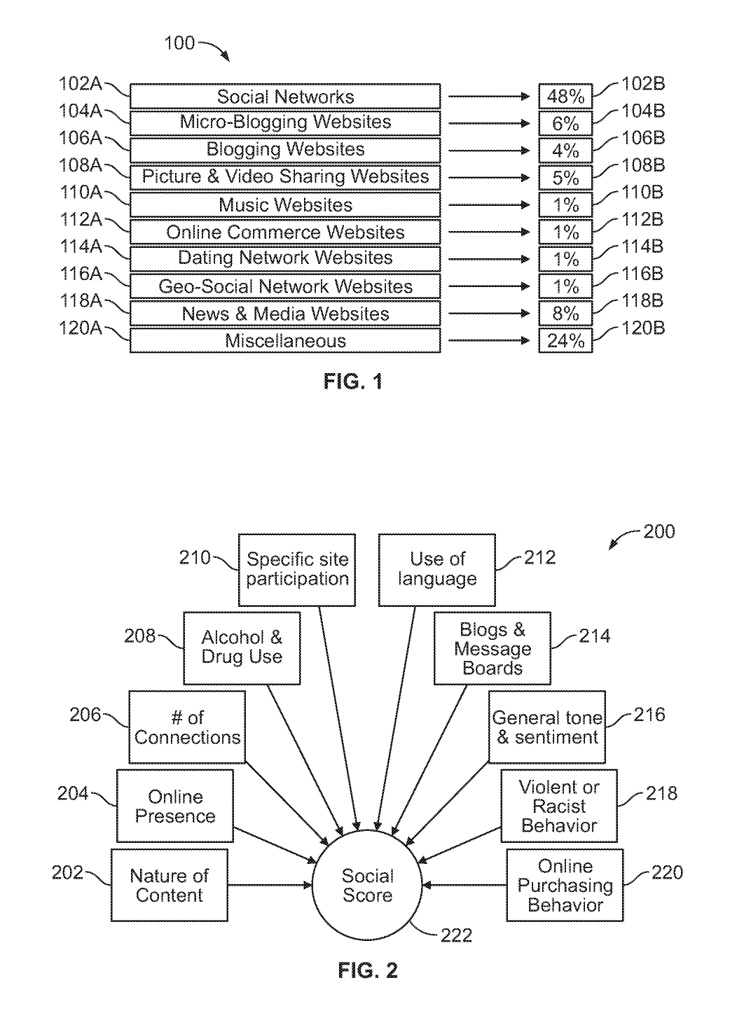

Referring now to FIG. 1, several data sources for the social scoring process are shown. One potential data source includes social networks 102a, such as Instagram, Facebook, LinkedIn, Meetup and other social networking websites. Another potential data source includes micro-blogging 104a and blogging 106a websites, such as twitter, StumbleUpon, WordPress, tumbler, livejournal, and other blogging websites. Yet another potential data source includes picture and video sharing websites 108a, such as YouTube, flickr, Flixster, and similar websites. As shown in FIG. 1, the above types of online data sources may generate a large portion of the data sourced for the analysis herein, and in this example the above sources provide over 60% of the source data (see 102b, 104b, 106b, and 108b). Further data may be collected from music websites 110a such as Spotify, Pandora, last.fm, and iLike; online commerce websites 112a such as ebay, alibaba.com, amazon.com, and Epinions.com; dating network websites 114a such as match.com, eHarmony, and tinder; geo-social network websites 116a such as foursquare, urbanspoon, and tripadvisor; and news & media websites 118a such as CNN, the New York Times, and the L.A. Times. Other miscellaneous websites 120a such as Mugshots.com, beeradvocate.com, hanggliding.org and others may also provide potential source data. The potential data sources identified in FIG. 1 are exemplary, and additional data sources may be included in the analysis.

Once raw data sources are collected for a target subject, an identity resolution engine is used to validate the subject data. Then the data is distilled into discrete data points for further analysis, based on specific factors (discussed below) determined through analysis of known data sets and validated subject content.

Turning to FIG. 2, an exemplary list of factors considered in the social score 222 is provided. The factors were determined using a sample set of 50,000 known outcomes, and are capable of further refinement through use of the social scoring process based on machine learning, which allows additional factors to be developed and existing factors to be adjusted. Therefore, the risk determination process can be continually updated based on continued experience with actual data. Factors considered may include the nature of content 202, online presence 204 (or lack thereof), number of connections 206, alcohol and drug use 208, specific website participation 210, use of language 212, blogs and message boards 214, general tone and sentiment 216, violent or racist behavior 218, online purchasing behavior 220, and other factors. Each factor for which data is available regarding a target subject may impact the ultimate risk determination. The ultimate risk determination is a recommendation based on the evaluation; in embodiments focused on insurance, the evaluation is a determination as to whether a subject would be a low insurance risk and/or less likely to commit insurance fraud.

For example, for a target subject having a LinkedIn account, the number of connections is considered. Based on the initial data set of known outcomes, subjects with 200 or more LinkedIn connections are lower risk, and this is therefore factored into the social score if applicable. As another example, a target subject exhibiting blatant violent and/or racist statements online is higher risk. As a third example, a target subject actively contributing to the New York Times or Wall Street Journal websites is lower risk. As a final example, a subject demonstrating alcohol abuse or illicit drug use is higher risk. For embodiments evaluating potential insurance risk, a social score indicating a lower risk subject indicates that the subject is a lower claim risk and/or less likely to commit insurance fraud.

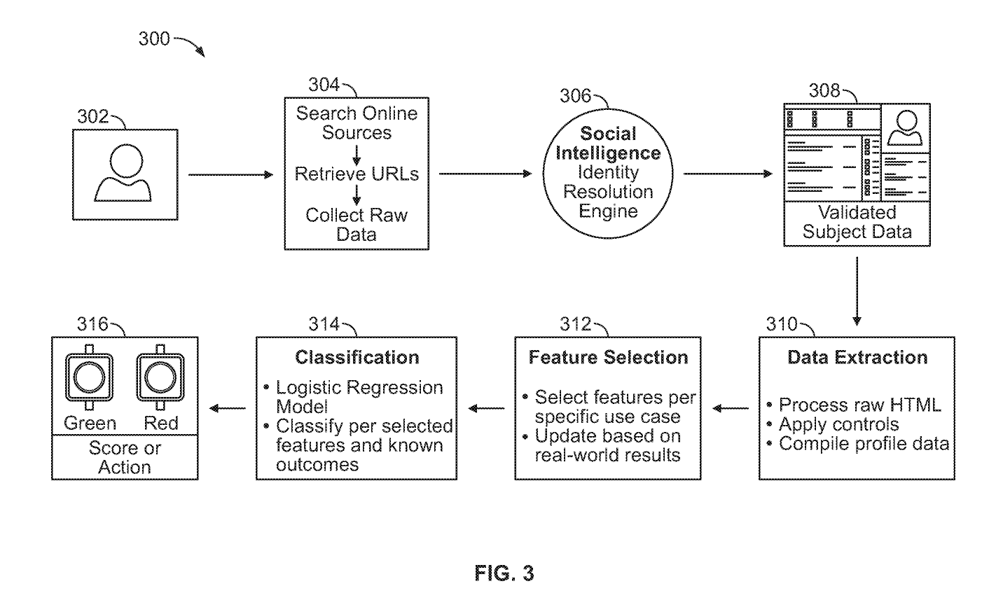

Turning to FIG. 3, a flowchart 300 detailing the process for analyzing a target subject and providing a green light report is provided. At 302, a target subject is identified. Then, at 304 publicly available online sources are searched, URL's are identified, and raw data is collected corresponding to the target subject. Next at 306, an identity resolution engine, such as the Social Intelligence® Identity Resolution Engine, is used to analyze the raw data and filter out data not applicable to the target subject, yielding the validated subject data at 308.

At 310, the validated subject data is processed and assembled into profile data. The validated subject data, which is in raw form, is distilled into individual components by removing extraneous content, such as HTML tags, javascript code, and other extraneous information. Next, according to some embodiments, in order to provide a consistent comparison across subjects, controls are applied to the data. Controls may be based on age, demographics, geographic region, and other factors in order to provide appropriate comparisons. As an example, a comparison of social media usage between a twenty-one (21) year old subject and a sixty (60) year old subject would be unlikely to yield an appropriate comparison, as the social media usage of the older subject is likely to be substantially less, and related factors, such as number of friends or connections, would likely be less as a result. Thus, controlling the data for age, in this example, provides for a more appropriate comparison relating to social media usage and related factors. Finally, the data is assembled into structured values and stored as a profile relating to the target subject.

At 312, discrete features of the subject profile are selected for further analysis. In some embodiments, the relevant features are selected based on the specific use case, such as insurance evaluation and/or quotation, employment assessment, business risk, or other use cases. According to some embodiments, a template for each specific use case is maintained, to identify the most desirable features for risk evaluation for that use case. In some embodiments, the template is adjusted based on additional data from actual outcomes.

The system 300 includes a large annotated database of data derived from known outcomes. According to some embodiments, this database is a customer contributory database that is further updated based on continuing information regarding the data set. For example, an insurer may contribute follow up information for target subjects regarding actual loss data. These additional known outcomes are stored in the database, and used to further refine the predictive social scoring process.

At 314, the target subject is classified by evaluating the selected features of the subject profile in comparison with the database information based on known outcomes. For embodiments providing a binary report, such as a green light or red light risk analysis, the risk scoring classification is performed using logistic regression to predict the expected outcome based on the selected features as predictive variables. In other embodiments, where more risk scoring assessment categories are desired, a multinomial logistic regression may be used, for example where target subjects are to be divided into low risk, medium risk, and high risk categories. Although logistic regression is provided in the preferred embodiment, it is understood that other statistical methods of predicting expected outcomes for a set of selected feature data may be utilized.

Ultimately, as shown at 316, according to some embodiments, a subject that is predicted to be a low risk is identified with a green light, and a subject that is predicted to be a high risk is identified with a red light. In other embodiments, a relative risk score is provided instead of a green or red light report. By identifying high risk subjects, according to some embodiments, an insurance company can avoid these subjects and transfer that risk to other insurers, such as their competitors. Similarly, according to other embodiments, a potential employer can avoid potential high risk employees who are more likely to expose the potential employer to human resource complaints and/or legal action. Furthermore, by identifying low risk subjects, evaluators can save time and money by avoiding more detailed reporting and/or investigation for these low risk candidates.

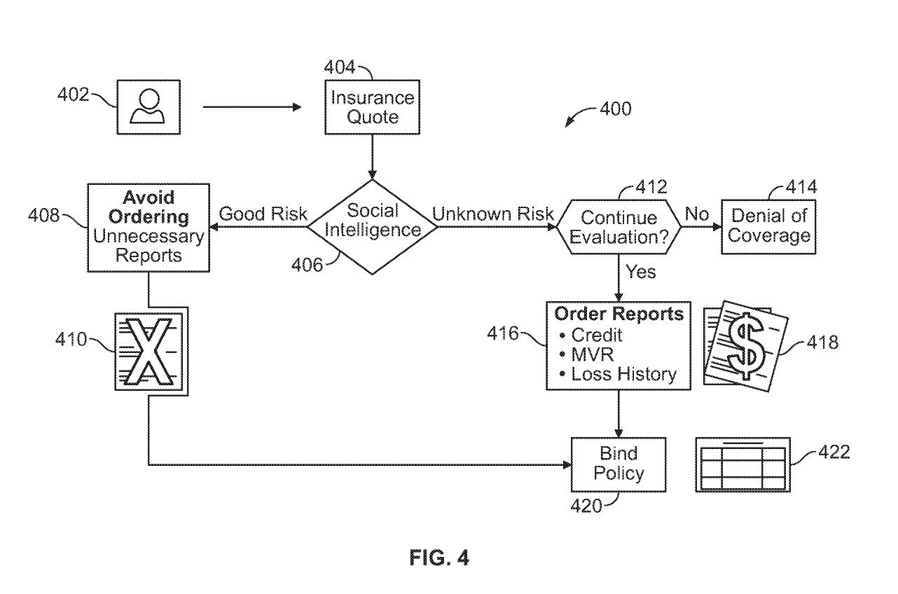

In FIG. 4, an exemplary embodiment of an insurance quote process is shown. In this embodiment, the applicant is applying for auto insurance, although the process can be applied to other types of insurance, or other processes where loss prediction is beneficial. At 402, an applicant for the auto insurance policy is identified, and at 404 the insurance quote process begins. The known information regarding the applicant is provided as input to the Social Intelligence process at 406, and that process provides a recommendation (for example, as detailed in FIG. 3). If the recommendation is good risk (or “green light”) the quote process proceeds to 408, where the process determines that no additional investigative reports are required (illustrated by 410). Therefore, the process continues to 420, where the policy is bound (illustrated by 422). Thus, for applicants identified as low risk, immediate cost savings are provided through the avoidance of extensive 3^{rd} party reports, by leveraging the world's largest contributory database—web-based social media.

On the other hand, going back to 406, if the recommendation is unknown risk (or “red light”) the quote process proceeds to 412. At 412, the potential insurer can decide whether to continue the evaluation of the applicant through further investigation, or opt to end the application process by denying coverage. If the evaluation is concluded with a denial of coverage 414, the potential insurer benefits by shifting the risk associated with this applicant away from them and to another insurer. Alternatively, the evaluation can continue by investigating additional data associated with the applicant.

At 416, the potential insurer will want to purchase additional information regarding the applicant (illustrated by 418), such as a credit report, motor vehicle report, loss history report, and/or other supplemental information in order to make a determination as to whether to insure the applicant. After evaluating the additional information, the insurer can then elect to insure the applicant and bind the policy at 420.

Alternatively, the recommendation of the risk prediction process at 406 can be provided as a numeric range or other scale of relative risk scores, instead of a green light/red light report. Additionally, the application process can utilize the relative risk score to determine whether to accept the application and/or perform further investigation, and/or at what price point the application should be granted. For example, in some embodiments, alternative payment plans result based on different relative risk scores. Furthermore, in embodiments related to loan applications, a poor risk prediction score can lead to a denial of the lending instrument.

Thus, the predictive social scoring process as set forth herein can identify potential low risk candidates, and allow a party assessing risk to dodge potential claims, reduce moral hazards, and/or shift the potential risk to their competitors by avoiding high risk applicants. Alternatively, the choice can be made to accept high risk applicants at an adjusted cost, such as, in the insurance context, higher premiums for high risk subjects. For example, in an alternative embodiment, applicants reaching 420 through additional investigation and reports 416 might be required to pay an increased application fee, in comparison to an applicant that reached 420 via 408. In still other embodiments, applicants that are identified as higher risk may be charged higher premiums.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the invention. It is also contemplated that additional embodiments according to aspects of the present invention may combine any number of features from any of the embodiments described herein.

1. A method for providing a risk assessment recommendation based at least in part on publicly available online information, comprising:
identifying a target subject for evaluation;
searching publicly available online information for content associated with the target subject, and collecting the content to generate raw data;
validating the raw data to generate validated subject data;
selecting a plurality of discrete features associated with the validated subject data;
receiving, from a database, one or more known outcomes associated with at least one of the plurality of discrete features;
providing a risk score for the target subject, based at least in part on an evaluation of the validated subject data in comparison with the one or more known outcomes.

2. The method of claim 1 wherein at least some of the publicly available online information is obtained from social media websites.

3. The method of claim 1 wherein the target subject is an applicant for an insurance policy.

4. The method of claim 1 wherein the target subject is an applicant for employment.

5. The method of claim 1 wherein the target subject is an applicant for a loan.

6. The method of claim 1 wherein the plurality of discrete features comprises at least one of illicit drug usage, number of online connections, or online purchase history.

7. The method of claim 1 wherein the risk score is reported as a numerical score.

8. The method of claim 1 wherein the risk score is reported as a letter grade.

9. The method of claim 1 wherein the risk score is reported as one of two possible options, and the risk score is determined using logistic regression.

10. The method of claim 1 wherein the risk score is reported as either a green light, corresponding with low risk, or red light, corresponding with high risk.

11. A system for providing a recommended action for a target subject and specific use case, comprising:
one or more processors in communication with an online computer network;
a database comprising known outcomes, the database communicatively coupled to at least one of the one or more processors; and
one or more memory devices storing instructions that, when executed by at least one of the one or more processors, cause the system to:
receive a request to evaluate a target subject in conjunction with the specific use case;
identify information relating to the target subject by searching the online computer network, and storing the identified information as target subject profile data;
select a plurality of features according to the specific use case;
receive known outcome information from the database for one or more of the selected features;
evaluate the target subject profile data in comparison to the known outcome information; and
determine a recommended action for the target subject and specific use case according to the evaluation.

12. The system of claim 11 wherein the specific use case is an employment application, a loan request, or an insurance application.

13. The system of claim 11 wherein the specific use case is an insurance application and the recommended action is either to insure or deny coverage to the target subject.

14. The system of claim 11 wherein the specific use case is an employment application, and the recommended action is a recommendation to employ or not employ the target subject.

15. The system of claim 11 wherein controls are applied to the subject profile data for at least one of age, race, sex, or residential location.

16. The system of claim 11 wherein the recommended action is reported as a green light or red light.

17. The system of claim 11 wherein the recommended action is determined using logistic regression.

18. The system of claim 11 wherein the recommended action is provided as a relative risk score for the target subject.

19. A method for determining an insurance quotation for a target subject, comprising:
receiving a request for an insurance quote for a target subject;
obtaining publicly available online data regarding the target subject;
verifying the obtained data and storing the verified data as target subject profile data;
determining a predictive score for the target subject from an evaluation of the target subject profile data in view of a plurality of known outcomes, wherein the predictive score is provided as a numerical risk score for the target subject; and,
providing an insurance rate quote based on the numerical risk score, wherein a lower predictive score is associated with a lower insurance rate quote.

20. The method of claim 19 wherein the publicly available online data comprises data from at least one of facebook, LinkedIn, twitter, tumblr, or Instagram.
